(19) United States
(12) Patent Application Publication
(10) Pub. No.: US 2013/0216236 A1
(43) Pub. Date: Aug. 22, 2013

(54) MANAGED OPTICAL COMPUTER NETWORK DEVICE

(71) Applicant: LIME BROKERAGE LLC, (US)

(72) Inventors: Sergey Bolberov, Acton, MA (US); Paul Zotov, Arlington, MA (US); Chad L. Cook, Uxbridge, MA (US); Richard J. Lavoie, Waltham, MA (US); Vitali Vinokour, Lexington, MA (US); Daniel Bergman, Brookline, MA (US)

(73) Assignee: LIME BROKERAGE LLC, Waltham, MA (US)

(21) Appl. No.: 13/772,817

(22) Filed: Feb. 21, 2013

Related U.S. Application Data
(60) Provisional application No. 61/601,662, filed on Feb. 22, 2012.

(51) Int. Cl. H04B 10/40

(52) U.S. Cl. CPC H04B 10/40
USPC 398/135

(57) ABSTRACT

A managed optical communication network device selectively passes or blocks an optical signal from an input port to an output port, based on state of the device. The device state may be managed remotely by sending management commands, according to a communication protocol, to the device. The device may be remotely controlled to selectively cut off all optical communications between two nodes, such as between two computers, between a local area network and a router, or between a router and a wide area network.

### CROSS REFERENCE TO RELATED APPLICATIONS

This application claims the benefit of U.S. Provisional Patent Application No. 61/601,662, filed Feb. 22, 2012, titled “Managed Optical Computer Network Device,” the entire contents of which are hereby incorporated by reference herein, for all purposes.

### TECHNICAL FIELD

The present invention relates to computer network devices and, more particularly, to managed on-off switching devices in optical computer networks.

### BACKGROUND ART

Optical computer network components, such as network interface cards (NICs), routers, switches and interconnecting optical fibers, are used in high-bandwidth computer networks. Some such networks carry primarily computer data, whereas other such networks carry a mixture of digitized voice and data or primarily digitized voice traffic. Similar optical components are used in optical carrier transmission systems, such as Synchronous Optical Networking (SONET) fiber optic networks deployed by telecommunications carriers. Computer networks and carrier systems are collectively referred to herein as communication networks or computer networks.

Lawful intercept (LI) involves obtaining communication network data pursuant to lawful authority for purposes related to analysis or evidence. Lawful intercept may, but need not, involve a law enforcement agency, regulatory or administrative agency or intelligence service. For example, operators of private communications networks have an inherent right to maintain lawful intercept capabilities within their own networks, such as for network maintenance and management purposes, unless otherwise prohibited from doing so.

A network test access port (TAP) is a device that provides means for obtaining information from a communication network. For example, a passive optical TAP splits a portion of a light signal passing through the device and provides the tapped portion of the signal via a monitor port. Analysis equipment coupled to the monitor port may monitor and analyze traffic that flows through the device, without delaying the traffic. All network traffic passing through a device is made available at the monitor port. On the other hand, a switched port analyzer (SPAN) is a device that provides a filtered version of traffic passing through the device to an analysis port. Such a device necessarily delays traffic passing through the device. However, a SPAN can simplify analysis of the traffic by passing only traffic of interest to the analysis port.

TAPS and SPANS are commonly used to monitor traffic on optical communications networks. Traffic is sometimes stored by an analysis node for later statistical analysis, such as to determine peak loads, error patterns or the like. Real-time analysis of traffic volume may be used to bring additional routes on line or to balance loads across several available routes. Law enforcement agencies and the like typically record voice traffic for later analysis or use as evidence. However, prior art communication network traffic monitoring tools provide limited means for controlling traffic passing through network devices.

### SUMMARY OF EMBODIMENTS

An embodiment of the present invention provides an optical network device. The device includes an input port, an output port, a control port, an optical on-off switch and a controller. The optical on-off switch is optically coupled between the input port and the output port. The switch has an “on” mode and an “off” mode. In the on mode, the switch allows an optical signal from the input port to pass through the switch. In the off mode, the switch prevents the optical signal to pass through the switch. The controller is coupled to the optical on-off switch and to the control port. The controller is configured to receive management commands, according to a computer network control protocol. The management commands are received via the control port. The controller is also configured to control the mode of the optical on-off switch, according to the received management commands.

The computer network control protocol may include a computer network management protocol. For example, the computer network control protocol may include Simple Network Management Protocol (SNMP).

The device may also include a monitor port and an optical tap. The optical tap may be coupled to the monitor port. In addition, the optical tap may be coupled between the input port and the output port. The optical tap may be configured to provide, to the monitor port, an optical signal that carries at least a portion of information carried by the optical signal from the input port.

The optical tap may be configured to direct a portion of the optical signal from the input port to the monitor port.

### BRIEF DESCRIPTION OF THE DRAWINGS

The invention will be more fully understood by referring to the following Detailed Description of Specific Embodiments in conjunction with the Drawings, of which:

FIG. 1 is a schematic block diagram of a managed optical network device, according to an embodiment of the present invention.

FIG. 2 is a schematic block diagram of a managed optical network device, according to another embodiment of the present invention.

FIG. 3 is a schematic block diagram of a managed optical network device, according to yet another embodiment of the present invention.

FIG. 4 is a schematic block diagram of an exemplary environment in which the optical network device of FIG. 2 or 3 may be advantageously utilized.

FIG. 5 is a schematic block diagram of another exemplary environment in which the optical network device of FIG. 2 or 3 may be advantageously utilized.

### DETAILED DESCRIPTION OF SPECIFIC EMBODIMENTS

According to embodiments of the present invention, a managed optical communication network device selectively passes or blocks an optical signal from an input port to an output port. The device state may be managed remotely by sending commands, according to a communication protocol, to the device. Thus, embodiments of the present invention may be remotely controlled to selectively cut off all optical communications between two nodes, such as between two computers, between a local area network and a router, or between a router and a wide area network.

In some embodiments, the optical device also includes a monitor port and an optical splitter that provides a portion of the optical signal from the input port to the monitor port. Thus, a monitor node coupled to the monitor port may be configured to automatically monitor traffic passing through the device and, in response to detecting a predetermined condition, the monitor node may be configured to automatically command the device to change to an “off” state, so as to prevent further traffic passing through the device. For example, a security monitor may automatically monitor traffic passing through the device and, if the security monitor detects a proscribed type of communication, the security monitor may command the device to stop all optical traffic passing through the device.

Unlike conventional optical computer network switches, the disclosed device either allows all optical signals (within the design specifications of the device, such as a designated range of wavelengths) to pass through the device, or the device blocks all optical signals (within the design specifications) from passing through. Thus, the device operates in one of two states. In contrast, conventional optical computer network switches include more than two input/output ports and selectively route packets arriving at an input port to one or more of the output ports, depending on addresses in the packets.

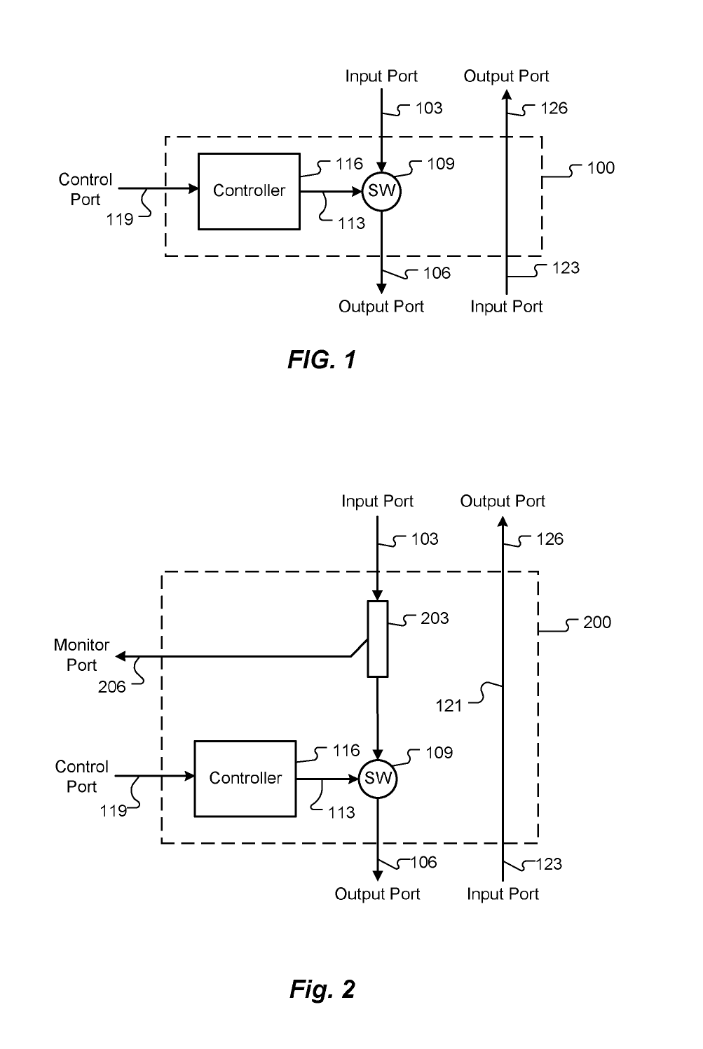

FIG. 1 is a schematic block diagram of a managed optical computer network device 100, according to an embodiment of the present invention. An input port 103 and an output port 106 are configured to accept conventional optical computer network cable connectors. A controllable on-off optical switch 109 interconnects the input and output ports 103 and 106. The controllable on-off optical switch 109 may be implemented with, for example, a mechanical optical switch, such as a model D1×2T mechanical optical switch available from Optic Network Technology Co., Ltd., No. 7 Gongren Road, Yuyao, Ningbo, Zhejiang, China. Such a switch is controllable by a voltage applied to a control lead 113.

In one type of mechanical optical switch, a prism is disposed in an optical path between an input and an output. The prism is mounted on a piezoelectric element, and a control lead is attached to the piezoelectric element. If a control voltage is applied, via the control lead, to the piezoelectric element, the element moves, thereby moving the prism so as to redirect the optical signal away from the optical path, thereby turning the optical switch off. A mechanical optical switch may be configured so the optical path is either “normally on” or “normally off” in the absence of the control signal.

Other types of optical switches may include mirrors or other optical elements, rather than prisms in the optical path. Depending on switching speed requirements, a liquid crystal may be used as the optical element. Similarly, other mechanical structures may be used to move the optical element. For example, an electromagnet may be coupled to a pivot table, and the optical element may be attached to the pivot table for pivoting therewith. If a purely electronic optical element, such as a liquid crystal, is used, no mechanical structure may be needed.

The controllable on-off optical switch 109 has an “on” mode and an “off” mode. In the on mode, the switch 109 passes optical signals (within the design specifications of the optical switch 109) from the input port 103 to the output port 106. In the off mode, the switch 109 prevents optical signals from passing from the input port 103 to the output port 106. Thus, passage of computer network traffic or communication traffic, presented as optical signals, from the input port 103 to the output port 106, can be controlled (i.e., permitted or blocked), based on the mode of the switch 109.

The on-off optical computer network device 100 also includes a controller 116. The controller 116 is coupled to a control port 119 configured to accept a computer network cable connector. In some embodiments, the control port 119 is configured to accept an optical computer network connector, and in other embodiments the control port 119 is configured to accept a “copper” computer network connector. Of course, an embodiment may include both optical and copper connectors coupled to the controller 116.

The controller 116 is configured to accept management commands according to a computer network protocol, such as Simple Network Management Protocol (SNMP), and to generate a signal that is applied to the control lead 113 of the optical on-off switch 109 and, thereby, control the mode of the switch 109. If SNMP is used, the controller 116 may be configured as an SNMP agent. Other well-known or proprietary management protocols may be used. The controller 116 may treat the optical switch 109 as a managed object, and the controller 116 may maintain a management information base (MIB) that represents the current mode of the switch 109.

The controller 116 may be configured to accept SNMP “SET” commands to set the mode of the switch 109. For example, in response to receipt of a SET command to set the mode of the object representing the switch 109 to “1,” the controller 116 may be configured to generate a signal (or to cease generating the signal, as the case may be) on the control lead 113 to turn the switch 109 on, and in response to a SET command to set the mode of the object to “0,” the controller 116 may be configured to generate a signal (or cease generating any signal, as the case may be) on the control lead 113 to turn the switch 109 off.

Similarly, the controller 116 may be configured to respond to GET and GET-NEXT commands by returning the current state of the switch 109, via GET-RESPONSE messages. Optionally, the controller 116 may be configured to send a TRAP message, if the controller 116 detects a fault in the switch 109, such as if the switch 109 fails to respond to a signal on the control lead 113, or if the controller detects a power failure or other fault.

In the embodiment shown in FIG. 1, the optical signal path represented by the input port 103, the switch 109 and the output port 106 is unidirectional. The optical computer network device 100 may include a second optical path 121 between a second input port 123 (equipped with a suitable optical computer network connector) and a second output port 126 (also equipped with a suitable connector).

In some embodiments, as shown in FIG. 1, the second optical path 121 does not include a switch, whereas in other embodiments (not shown), the second optical path 121 includes a second optical switch, similar to the first switch 109, and the controller 116 is configured to control operation of the second optical switch in a manner similar to that described above. The second optical switch may be controlled in tandem with the first optical switch (i.e., both optical switches may be turned on together and turned off together), or the two optical switches may be treated as separate managed objects, each with its own object identification (OID) and, therefore, independently operable. The first and second optical paths collectively provide send and receive paths for a computer or communication network link. Other embodiments (not shown) include only one bi-directional optical path with an optical switch therein.

The controller 116 may be implemented with any suitable hardware, software, firmware or hybrid unit. For example, the controller 116 may be implemented with a suitably programmed single-board computer, such as a model PEB-2771VG2A single-board computer, available from Portwell, Inc., 44200 Christy St., Fremont, Calif. 94538.

FIG. 2 is a schematic block diagram of another embodiment of an optical computer or communication network device 200, according to the present invention. The device 200 includes input and output ports 103 and 106, an optical on-off switch 109, a controller 116 and a control port 119, as in the embodiment described above, with respect to FIG. 1. However, in addition, the embodiment show in FIG. 2 includes an optical tap 203. The optical tap 203 may be implemented with an optical splitter, a network traffic analysis point (TAP), a switch port analyzer (SPAN) or any other suitable device that provides an optical signal that carries at least a portion of the information carried by the optical signal received at the input port 103. The optical tap 203 may provide literally a portion of the optical energy received at the input port 203, or the optical tap 203 may generate an optical signal that carries all or part of the information carried by the optical signal received by the input port 103. A TAP is a passive splitting mechanism that directs a portion of the optical signal from the input port 103 to the monitor port 206. A SPAN is an active device that provides a copy of the optical signal from the input port 103, although a SPAN filters out physical layer errors and may be programmed to provide additional filtering.

The monitor port 206 is configured with a suitable optical network cable connector. Thus, a separate system (not shown) may receive a copy of, and therefore monitor, computer or communication network traffic passing through the tap 203. As will be described below, the separate system may send commands to the controller 116 to control the state of the optical on-off switch 109, in response to detecting proscribed network traffic on the monitor port 206, or for other reasons.

As discussed above, with respect to FIG. 1, the second optical path 121 may include a second switch (not shown). The second optical path 121 may also include a second optical tap (not shown). Outputs from the two taps may be provided to separate respective monitor ports, or they may be aggregated by an appropriate circuit (not shown) and provided to a single monitor port.

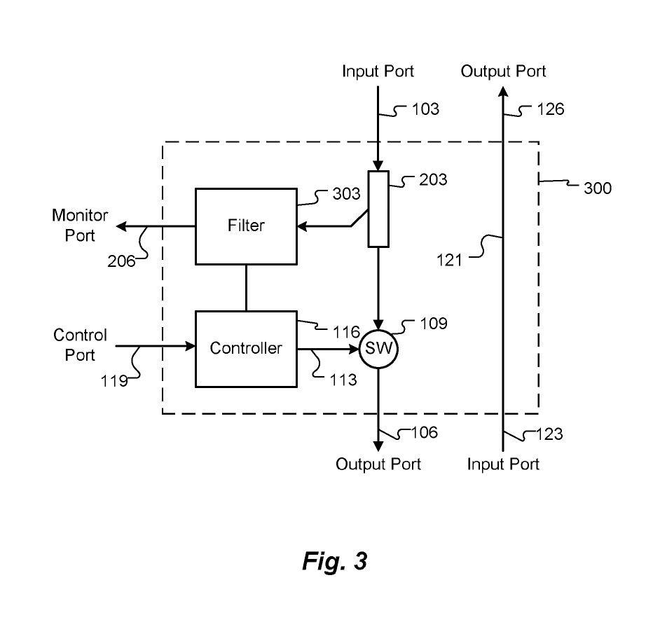

FIG. 3 is a schematic block diagram of yet another embodiment of an optical computer or communication network device 300, according to the present invention. The device 300 includes input and output ports 103 and 106, an optical on-off switch 109, a controller 116, a control port 119 and a monitor port 206, as in the embodiment described above, with respect to FIG. 2. However, in addition, the embodiment show in FIG. 3 includes a filter 303 configured to pass only a predetermined or programmable type of traffic. For example, the filter 303 may be configured to pass all traffic between a particular client computer and a particular financial market (ex. NASDAQ). The filter 303 may be implemented by any suitable hardware, software, firmware or hybrid unit, such as a suitably programmed single-board computer. The filter 303 may be implemented by the same structure that implements the controller 116 or by a separate structure. The control structure for the filter may be configured to set parameters of the filter, such as what kinds of traffic to pass, in response to management commands received via the control port 119.

It should be noted that the optical computer network device 100 (FIG. 1), 200 (FIG. 2) and 300 (FIG. 3) each is unlike a conventional network switch, which directs network traffic from an input port to one of several output ports, such as based on destination address of the traffic. Instead, the inventive devices 100, 200 and 300 each has only one output port for each input port and either enables or disables all optical signals (within the design specifications of the switch) to travel from the input port to the output port. The device is controlled by network management commands, such as SNMP commands. Thus, the device is “managed.” Although each optical computer network device 100, 200 and 300 has been described as being controllable by management commands sent according to the SNMP protocol, any suitable control protocol that involves packets containing management commands may be used. However, a simple voltage, such as the voltage applied to the control lead 113 of the optical on-off switch 109 (FIGS. 1, 2 and 3) is not a “command” according to a “control protocol,” as these terms are used herein.

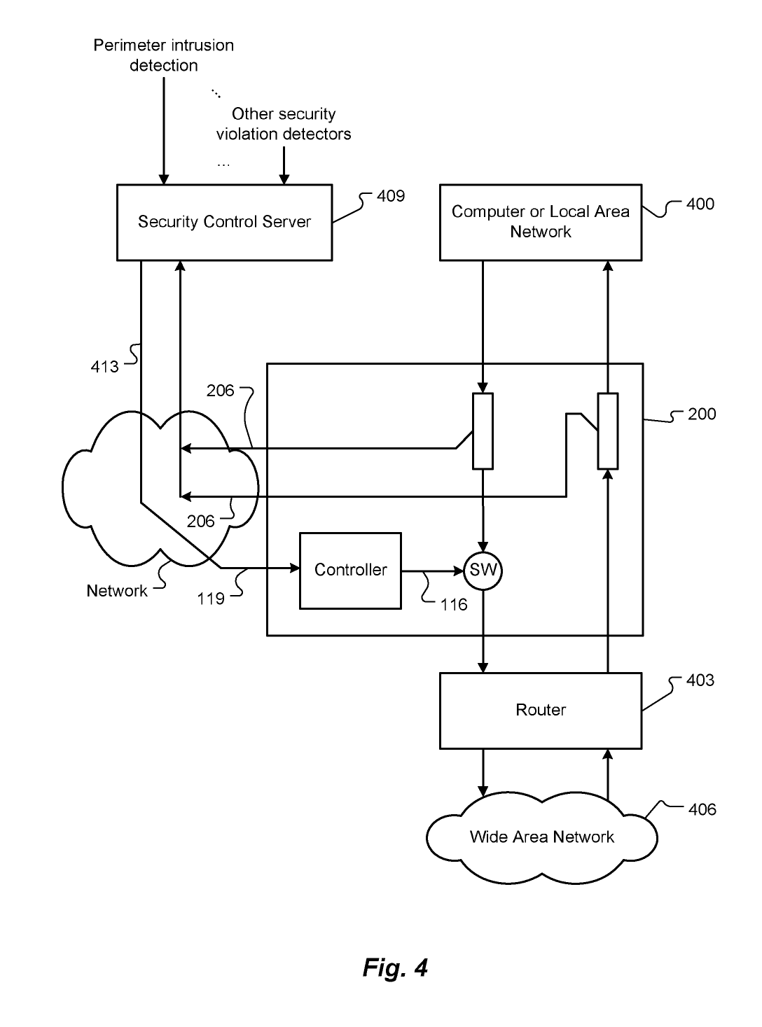

FIG. 4 is a schematic block diagram of an exemplary environment in which the optical network device 200 or 300 of FIG. 2 or 3 may be advantageously utilized. (The block diagram of FIG. 4 includes an optical network device 200; however, a device 300 may be substituted with appropriate changes to the security control server 409.) A computer or local area network 400 may be coupled via the optical network device 200 and a router 403 to a wide area computer network 406, such as the Internet, or to another computer or network. A security control server 409 may be configured to receive signals from perimeter intrusion detection hardware and/or to automatically detect other security violations based on signals from other security violation detectors, such as motion sensors, body heat sensors, floor pressure plates, security cameras, virus detection software being executed by the computer or a computer coupled to the local area network 400, etc.

Optionally or alternatively, the security control server 409 may be coupled to one or both of the monitor port(s) 206 of the optical network device 200. The security control server 409 may be configured to monitor network traffic from and/or to the computer or local area network 400 via the monitor port(s) 206 and automatically detect proscribed types of traffic, such as spam e-mail messages generated by a computer virus that has infected the computer or one of the computers on the local area network 400.

If the security control server 409 detects a break-in or proscribed traffic or another predetermined event or situation, the security control server 409 may be configured to issue a management command, via a network link 413 and the control port 119 of the optical network device 200, to instruct the device 200 to disable outgoing network connectivity between the computer or local area network 400 and the router 403. Optionally, such as in response to a reset command from a human operator or automatic detection of resolution of the security breach that lead to the disablement of the outgoing network connectivity through the device 200, the security control server 409 may be configured to issue a management command to the optical network device 200 to cause the device 200 to re-enable the outgoing network connectivity.

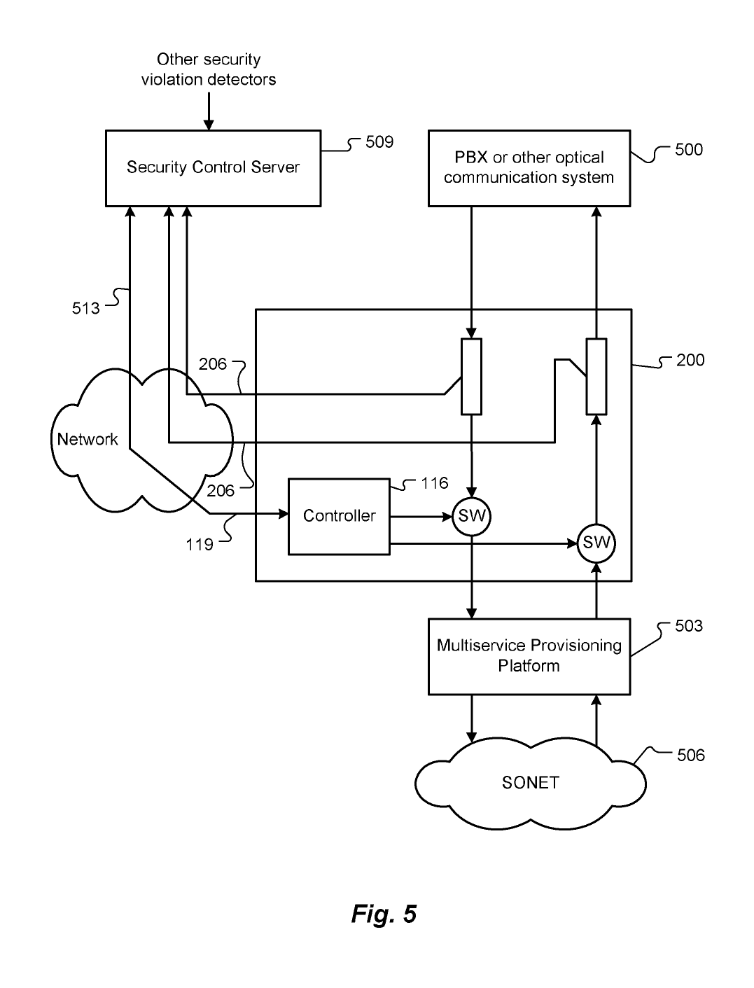

FIG. 5 is a schematic block diagram of another exemplary environment in which the optical network device 200 or 300 of FIG. 2 or 3 may be advantageously utilized. (The block diagram of FIG. 5 includes an optical network device 200; however, a device 300 may be substituted with appropriate changes to the security control server 509.) A private branch exchange (PBX) or other optical communication system 500 may be coupled, via the optical network device 200 and a multiservice provisioning platform (MSPP) 503 or other appropriate communication gateway, to an optical communication network, such as a SONET network 506. A security control server 509 may be configured to automatically detect security violations or other events or situations, as described above with respect to FIG. 4, and/or to monitor (via the monitor ports 206 of the optical network device 200, as described above) voice or other traffic traversing the device 200.

If the security control server 509 detects a situation, such as an intrusion or voice traffic destined to (or signaling traffic initiating a call to) a proscribed called party telephone number or a call from a proscribed calling party telephone number, the security control server 509 may be configured to automatically issue a management command, via a network link 513 and the control port 119 of the optical network device 200, to instruct the device 200 to disable one or both the incoming and/or outgoing optical links between the PBX or other system 500 and the MSPP 503. Optionally, such as in response to a reset command from a human operator or automatic detection of resolution of the situation that lead to the disablement of the connectivity through the device 200, the security control server 509 may be configured to issue a management command to the optical network device 200 to cause the device 200 to re-enable the connectivity.

The controller 116 and the security control server 409/509 may each be implemented by a processor executing instructions stored in a respective memory. The memory may be random access memory (RAM), read-only memory (ROM), flash memory or any other memory, or combination thereof, suitable for storing control software or other instructions and data. Some of the functions performed by the system have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof Those skilled in the art should also readily appreciate that instructions or programs defining the functions of the present invention may be delivered to a processor in many forms, including, but not limited to, information permanently stored on tangible, non-transitory, non-writable storage media (e.g. read-only memory devices within a computer, such as ROM, or devices readable by a computer I/O attachment, such as CD-ROM or DVD disks), information alterably stored on tangible, non-transitory, writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of the illustrated embodiments may be made without departing from the inventive concepts disclosed herein. For example, although some aspects of the system have been described with reference to a flowchart, those skilled in the art should readily appreciate that functions, operations, decisions, etc. of all or a portion of each block, or a combination of blocks, of the flowchart may be combined, separated into separate operations or performed in other orders. Furthermore, disclosed aspects, or portions of these aspects, may be combined in ways not listed above. Accordingly, the invention should not be viewed as being limited to the disclosed embodiments.

What is claimed is:

1. An optical network device, comprising:
an input port;
an output port;
a control port;
an optical on-off switch optically coupled between the input port and the output port, the switch having an on mode, in which the switch allows an optical signal from the input port to pass through the switch, and an off mode, in which the switch prevents the optical signal to pass through the switch; and
a controller coupled to the optical on-off switch and to the control port and configured to:
receive management commands, according to a computer network control protocol, via the control port; and
control the mode of the optical on-off switch, according to the received management commands.

2. An optical network device according to claim 1, wherein the computer network control protocol comprises a computer network management protocol.

3. An optical network device according to claim 1, wherein the computer network control protocol comprises Simple Network Management Protocol (SNMP).

4. An optical network device according to claim 1, further comprising:
a monitor port; and
an optical tap coupled to the monitor port and between the input port and the output port and configured to provide, to the monitor port, an optical signal that carries at least a portion of information carried by the optical signal from the input port.

5. An optical network device according to claim 4, wherein the optical tap is configured to direct a portion of the optical signal from the input port to the monitor port.
